(19) United States
(12) Patent Application Publication
(10) Pub. No.: US 2025/0021897 A1
(43) Pub. Date: Jan. 16, 2025

(54) GENERATING PREDICTIONS AND/OR OTHER ANALYSES USING ARTIFICIAL INTELLIGENCE

(71) Applicant: Onto Innovation Inc., Wilmington, MA (US)

(72) Inventors: Mustansir BANATWALA, Hudson, NH (US); Michael G. McINTYRE, Methuen, MA (US); William J. MARTIN, Boylston, MA (US)

(21) Appl. No.: 18/767,010

(22) Filed: Jul. 9, 2024

Related U.S. Application Data
(60) Provisional application No. 63/512,869, filed on Jul. 10, 2023.

(51) Int. Cl. G06Q 10/04; G06N 20/00; G06Q 50/04

(52) U.S. Cl. CPC G06Q 10/04; G06N 20/00; G06Q 50/04

(57) ABSTRACT

A method for predicting an aspect of semiconductor fabrication processes using machine learning. The method involves building a machine learning model that incorporates two parameters of manufactured semiconductor articles that are associated with different physical attributes of the semiconductor articles at different levels of granularity. A mathematical relationship between the two parameters is provided to the computing device, and the machine learning model is used to generate a semiconductor fabrication process prediction. By training the model with data associated with partially fabricated semiconductor articles, missing parameter values can be assigned using the mathematical relationship. This approach improves prediction accuracy and speed. The method has potential applications in the semiconductor industry, particularly for predicting aspects of semiconductor fabrication processes such as metrology, process optimization, and yield prediction.

### CROSS-REFERENCE TO RELATED APPLICATION

This application claims the benefit of U.S. Provisional Application No. 63/512,869, filed Jul. 10, 2023, and titled “Generating Predictions and/or Other Analyses Using Artificial Intelligence,” the disclosure of which is hereby incorporated herein by reference.

### TECHNICAL FIELD

The present disclosure relates generally to semiconductor fabrication, and more particularly to building a model for predicting outcomes of semiconductor fabrication processes with curated data and deploying the model with known relationships between parameters of the curated data.

### BACKGROUND

Model building in the semiconductor fabrication industry involves creating mathematical or statistical models to predict the behavior of various processes and variables involved in the production of semiconductor devices. These models are used to optimize the production process, improve yield, and minimize defects. However, as technology has evolved and the semiconductor industry has become more complex, the models used have also become more complex. The models now incorporate more variables and interactions between them, and the data sets used to build the models have become larger and more diverse.

This increasing complexity of the models has made them difficult to maintain and update, as well as requiring a significant amount of computational power and resources to run. Additionally, as the models have become more complex, they have become more difficult to interpret and explain to those who are not experts in the field.

### SUMMARY

In general terms, the present disclosure relates to improvements in models used to predict manufacturing outcomes, such as to predict defects in semiconductor fabrication processes.

In one aspect, the present disclosure relates to a method of predicting an aspect of a semiconductor fabrication process, including: building a machine learning model, including: providing, to a computing device, two parameters of one or more manufactured semiconductor articles, the two parameters being associated with different physical attributes of the one or more semiconductor articles that are at different levels of granularity; and providing, to the computing device, a mathematical relationship between the two parameters based on the different levels of granularity; and generating, by the machine learning model, a prediction of the semiconductor fabrication process.

In another aspect, the present disclosure relates to a computer system for predicting an aspect of a semiconductor fabrication process, including: one or more processors; and non-transitory computer-readable storage media encoding instructions which, when executed by the one or more processors, cause the computer system to: build a machine learning model by: providing, to a computing device, two parameters of one or more manufactured semiconductor articles, wherein the two parameters are associated with different physical attributes of the one or more semiconductor articles that are at different levels of granularity; and providing, to the computing device, a mathematical relationship between the two parameters; and generate, by the machine learning model, a prediction of the semiconductor fabrication process.

In another aspect, the present disclosure relates to a method of predicting an outcome of a semiconductor fabrication process, including: measuring a first physical attribute and a second physical attribute of one or more manufactured semiconductor articles, the first physical attribute being introduced to the one or more manufactured semiconductor articles before the second physical attribute and at a different fabrication step than the second physical attribute; determining a first order effect on the outcome by the first physical attribute and a second order effect on the outcome by the second physical attribute, the second order effect being smaller than the first order effect; and training a machine learning model to make predictions based on the first order effect and the second order effect.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 depicts an example computer system for predicting an aspect of a semiconductor fabrication process.

FIG. 2 depicts different levels of granularity associated with physical attributes of a manufactured semiconductor article.

FIG. 3 depicts an example curation of physical characteristics observed at different levels of granularity during fabrication of a semiconductor article.

FIG. 4 depicts an example semiconductor article fabrication process involving a series of steps in which one or more physical attributes are observed.

FIG. 5 depicts example physical components of the yield output engine of FIG. 1.

FIG. 6 depicts the yield output engine of FIG. 5 including a plurality of engines configured as specialized components adapted to perform specific computational processing tasks.

FIG. 7 depicts an example method of building a machine learning model with curated data and known relationships between parameters using the computer system of FIG. 1.

FIG. 8 depicts an example feedforward network machine learning model that can be used by the computer system of FIG. 1.

FIG. 9 depicts an example recurrent network machine learning model that can be used by the computer system of FIG. 1.

FIG. 10 depicts an example output representing predictions of semiconductor fabrication processes based on partially fabricated articles and using the computer system of FIG. 1.

### DETAILED DESCRIPTION

This disclosure relates to a computer system and method for predicting an aspect of a semiconductor fabrication process.

Various factors in the area of semiconductor fabrication have contributed to the increasing complexity of models used to make predictions about the fabrication processes.

One such factor is granularity. Data is collected at different levels of granularity, such as at a wafer level, a die level, or a region of a die level. For example, information about a transistor's speed may be collected at the individual die unit level, while other information may be collected at a site level. Some of the data is also collected on a fractional sampling basis, where only a few specimens from a lot are tested. This varying level of data collection makes it difficult to integrate and analyze the data in a meaningful way.

Another such factor is the inherent ordered effects within the fabrication process. Ordered effects during semiconductor fabrication can also complicate the accuracy of model predictions. For instance, modifying an input variable early in the process may have a different effect than intended due to the ordered effects of subsequent process steps. For example, the sequence in which deposition and etching steps are performed can impact yield. These ordered effects make it challenging to predict the behavior of processes accurately and highlight the need for more sophisticated modeling techniques.

Some aspects of the disclosure are directed to building a faster and more accurate machine learning model for predicting aspects (e.g., yield, fabrication tool maintenance, metrology tool maintenance, or another optimization aspect) of complex manufactured articles, such as semiconductor devices. Semiconductor devices can be fabricated on, e.g., multi-layered substrates, such as wafers and panels. For example, a wafer can include multiple dies, each containing a functional circuit. Fabricating a wafer requires many different steps (e.g., deposition steps, lithography steps, etching steps) performed in sequence and by different tools or systems. Yield is a measurement based on the percentage of good dies, wafers, or other units in a given fabrication run that meet quality standards and are free from killer defects introduced during the fabrication process.

Typically, a machine learning model is fed data (e.g., metrology data) with corresponding known outcomes (e.g., known yields) from prior fabrication runs to train the model. The model then trains itself. Once the model is trained, new data is fed to the model to generate a prediction (e.g., a predicted yield) based on the new data. However, inefficiencies in the model are inevitable. For example, the model can apply importance to parameters that is not warranted or irrelevant (which wastes time and computing resources) and neglect or undervalue parameters that are actually important to a prediction (which can produce poor predictions). In addition, the model can form incorrect relationships or functions between parameters at different levels of granularity, or simply fail to recognize mathematical links between different order effects in the fabrication process. In addition, the model can become reliant on specific data parameters to generate a prediction. If the input data is missing one or more parameters, which is common, the model simply fails to generate any prediction whatsoever, or guesses the missing parameters, but the guesses are often based on incorrect parameter relationships assumed by the model.

Aspects of the present disclosure improve model performance (speed and accuracy), particularly for models that predict one or more aspects of a semiconductor device or associated fabrication tool or system. Specifically, aspects of the present disclosure relate to building a model with curated data and providing the model with known relationships between parameters of the curated data. The data is curated to minimize its under-inclusiveness and over-inclusiveness depending on the types of prediction(s) to be made by the model. For example, for certain types of predictions, certain metrology data may be irrelevant and therefore excluded from the model. Parameter relationship information that is provided to the model being built can include, for example, relationships between parameters at different levels of granularity, and relationships between parameters at different order effects.

According to specific examples of relationships between parameters at different levels of granularity, metrology data exists at a die level (relatively large level of granularity) and site level (relatively small level of granularity). An example of a die level parameter is transistor speed. An example of a site level parameter is via resistance. The transistor speed depends on multiple factors from both larger levels of granularity and smaller levels of granularity, such as the critical dimension of the gate, the width of the side walls, the implant angle, the via resistance, and so forth. There is a direct relationship between the device's transistor and each of these other parameters, at least some of which are at different granularities. Because they are at different levels of granularity there is not a one-to-one unit to unit match function. For example, X1 impacts X3 because X2 impacts X3 and X1 impacts X2. Moreover, each of these factors can impact the transistor speed at different orders of magnitude. Thus, a typical model would fail to appreciate the direct relationships between the parameters at different levels of granularity and orders of magnitude. According to the present technology, all this information is known and can be provided to the model to build a more efficient model.

Models built with this knowledge, can provide better predictions. The models can also be better equipped at handling missing parameters. For example, if metrology data from a test wafer that is being fabricated is missing a parameter (e.g., a parameter that normally will not be available until a later stage in the fabrication) that the model uses to generate a prediction (e.g., a yield prediction), the model can apply the known parameter relationships to extrapolate the missing data. For example, the test wafer data may be missing implant angle data. Because the model is trained with the interrelationships between the parameters, the model can, in some examples, extrapolate the missing implant angle data based on known parameters of the test wafer and their functional relationships to the implant angle. In other examples, the model knows that the order of magnitude impact of the missing implant angle data is minimal on the overall prediction, and so the missing data can instead be guessed, e.g., using an average implant angle, from prior wafers.

The concept described involves an approach to enhance semiconductor fabrication processes through advanced data analytics and machine learning techniques. This concept revolves around collecting, processing, and utilizing data at various stages of semiconductor fabrication to predict aspects such as yield, tool maintenance, and other process optimizations. One component of this concept is a system that integrates several functional elements to handle data from its collection through to the prediction outputs.

In some embodiments, the concept has the capability to gather comprehensive metrology data from different phases of the semiconductor manufacturing process. This data can encompass both physical and electrical properties of semiconductor materials, collected through various metrology tools and/or inspection tools integrated into the manufacturing system. The stored data is then structured in a way that facilitates easy access and efficient processing, making it ready for further analytical tasks.

An execution engine utilizes the structured data to perform complex algorithms that predict the yield and other relevant outcomes of semiconductor fabrication processes. This engine is supported by user interfaces that allow for real-time interaction and configuration to adapt to ongoing manufacturing needs. Further sophistication is added through a yield output engine, which works in conjunction with the runtime execution engine. This engine employs advanced modeling techniques to analyze the processed data and generate predictions. It is particularly adept at handling challenges such as data granularity and missing data elements, employing specialized algorithms to resolve these issues.

The concept also involves understanding and establishing mathematical correlations between various physical attributes measured during the fabrication process. These attributes, which vary in their levels of granularity, can play an important role in developing a machine learning model that can accurately predict different outcomes based on the relationships between these attributes.

Overall, the present technology provides a comprehensive approach to integrating advanced data analytics and machine learning to enhance the efficiency and output of semiconductor manufacturing processes. By leveraging detailed data collection, sophisticated data processing, and advanced predictive modeling, improvements in the predictability and reliability of semiconductor fabrication outcome are possible.

Reference will now be made in detail to exemplary aspects of the present disclosure that are illustrated in the accompanying drawings. Wherever possible, the same reference numbers will be used throughout the drawings to refer to the same or like parts.

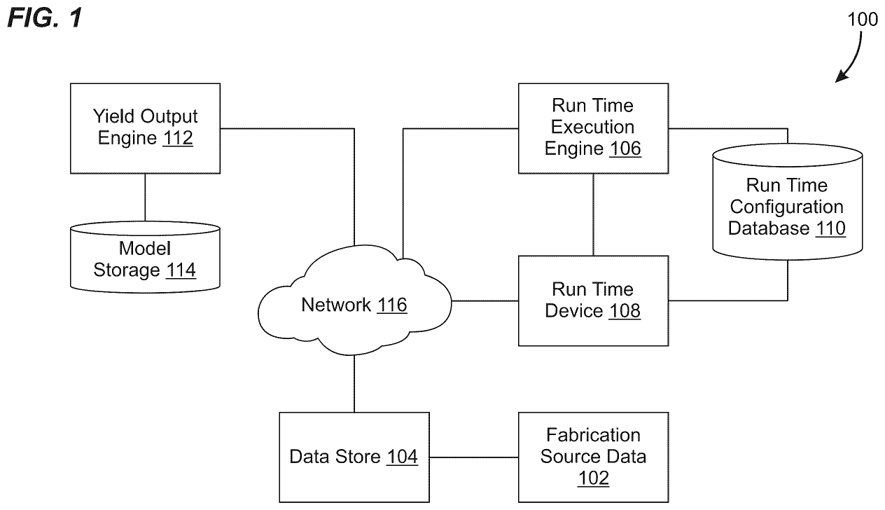

Referring to FIG. 1, a computer system 100 is illustrated an includes several components interconnected via a network 116, each with potential functionalities aimed at enhancing predictions within semiconductor fabrication processes.

The fabrication data source 102 can serve as a source for semiconductor fabrication data, encompassing collections of metrology data gathered throughout various stages of the fabrication process. This data, which may encapsulate physical and electrical properties of semiconductor materials, can be collected during different phases of manufacturing. The data store 104 has the capability to serve as a repository for data received from fabrication data source 102. The data within the data store 104 can be structured to facilitate easy access and processing by other components of the computer system 100. Additionally, the data store 104 can accommodate modifications to data, such as normalization or aggregation, to ensure compatibility and enhanced utility for downstream processing tasks.

The runtime execution engine 106 can utilize the structured data from the data store 104 to execute algorithms that can predict the yield of semiconductor fabrication processes. The runtime execution engine 106 is configurable through the runtime device 108 to provide insights and real-time data analysis to the ongoing fabrication.

The runtime device 108 can act as a user interface equipped with necessary hardware resources to control the runtime execution engine 106. The runtime device 108 can include various forms of computing hardware, such as personal computers, servers, or mobile devices, enabling users to enter commands and view outcomes of the computational processes. The runtime configuration database 110 can store settings and configurations for the runtime execution engine 106, preserving user-defined settings across system operations and ensuring they guide the execution processes effectively.

The yield output engine 112 can cooperate with the runtime execution engine 106 to analyze processed data to estimate the yield of semiconductor fabrication processes. The yield output engine 112 can use advanced modeling techniques stored in model storage 114 to predict outcomes based on integrated data from the data store 104. Additionally, the yield output engine 112 can address challenges such as data granularity and missing data elements by implementing specialized algorithms designed to manage such complexities. The model storage 114 can house algorithms and computational models that the yield output engine 112 can employ.

The network 116 represents the communication infrastructure that connects all components of the computer system 100. The network 116 can facilitate the seamless exchange of data and instructions among the components, ensuring that the computer system 100 operates as a cohesive unit. The network 116 can include various forms of digital communication pathways, such as local and wide area networks, providing secure and reliable data transmission.

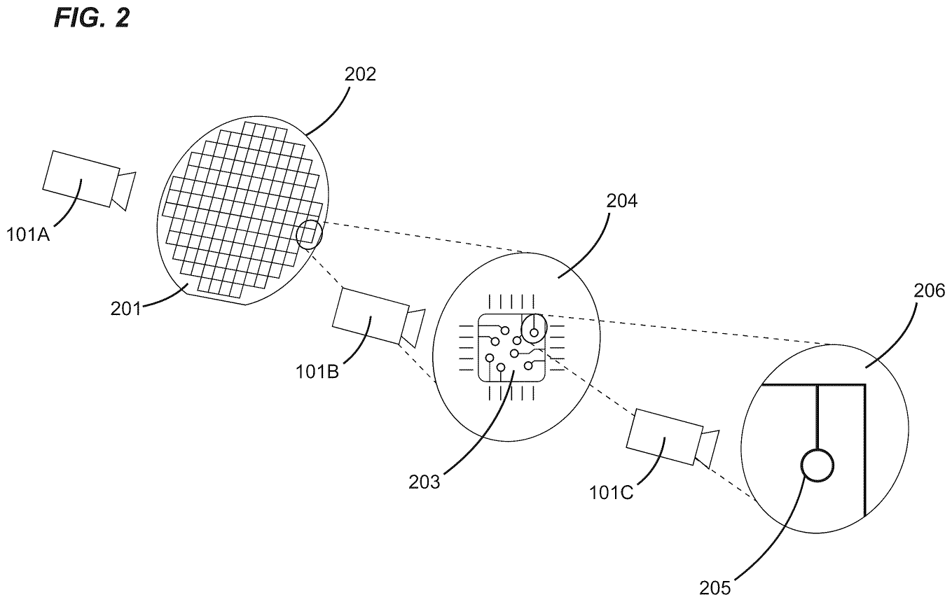

As further depicted in FIG. 2, data in the semiconductor fabrication process can be collected by the fabrication data source 102 at various levels of granularity, such as at the wafer level 202, die level 204, or regional level 206. Metrology data, for instance, exists at both the die level 204 (relatively large granularity) and the regional level 206 (relatively small granularity). In this particular example, a first physical attribute 201 (e.g., data X1) is collected at the wafer level 202, a second physical attribute 203 (e.g., data X2) is collected at the die level 204, and a third physical attribute 205 (e.g., data X3) is collected at the regional level 206. For example, the first, second and third physical attributes 201, 203, 205 can be collected via a camera, sensor or other metrology and/or inspection tools 101A, 101B, and 101C, incorporated into a semiconductor article manufacturing process or system.

At the wafer level, several metrics can be assessed to ensure the quality and consistency of semiconductor fabrication processes. These metrics can include the measurement of wafer thickness and uniformity across the entire wafer, which is important for maintaining consistency in subsequent processing steps. The flatness of the wafer surface can also be evaluated as it is essential for processes like lithography where uniformity is important. Additionally, the defect density on the wafer surface can be monitored, with a high defect density potentially leading to reduced yields. The level of particulate contamination on the wafer can be measured to assess its impact on device reliability and yield. The electrical resistivity of the silicon material is another often measured metric, as it can influence the performance of electronic devices. Moreover, the quality of the silicon dioxide layer can be analyzed due to its important role in the performance of many semiconductor devices.

At the die level, metrics such as critical dimension measurements can be conducted to ensure that the dimensions of circuit elements are within design specifications. Transistor performance metrics, including threshold voltage and drive current, can be evaluated to gauge the performance level of transistors on the die. Electrical testing can be performed on each die to detect failures before further packaging processes. Leakage current, which measures the current that leaks through a transistor when it is supposed to be off, can also be monitored as a potential indicator of reliability issues. Furthermore, the accuracy with which different layers of the device align during the lithography steps, known as overlay accuracy, can be measured.

At the regional level, various metrics can also be considered. These include localized defect reviews, which can involve detailed analyses of defects within specific regions of a die or wafer to understand localized issues in the fabrication process. The measurement of film thickness in specific regions can be critical to ensure uniform deposition or etching processes. Stress measurement in semiconductor layers, which can precipitate device failure, can be performed specifically in regions known to be susceptible. The concentration of dopants in specific regions can be measured, as it is important for device operational characteristics. Also, optical and electrical characteristics, such as reflectivity and conductivity, can be assessed in specific regions to verify process uniformity and material quality.

In the example depicted, each of the physical attributes 201, 203, 205 exists at different levels of granularity, thereby complicating the establishment of a one-to-one unit match function. Additionally, data corresponding to a specific level of granularity may be absent or incomplete, presenting further challenges in the construction and accuracy of models. Such absence of data can significantly impede the ability to perform accurate predictions and assessments within semiconductor manufacturing processes.

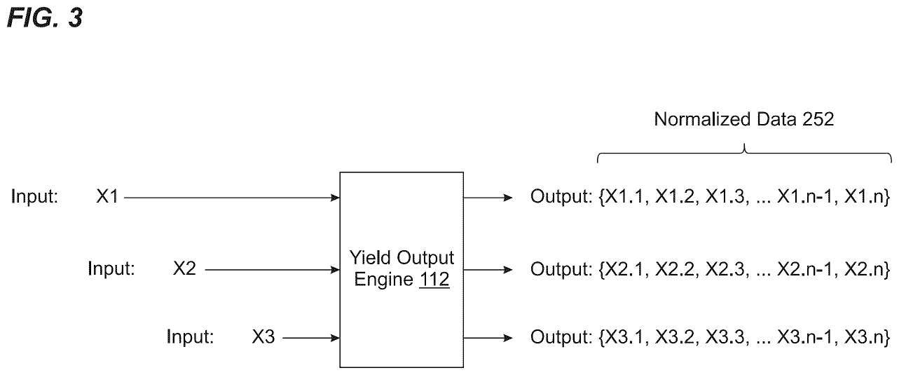

With further reference to FIG. 3, the present disclosure proposes a methodology production of normalized data 252 to address the issue of varying levels of granularity. To accommodate the disparate levels of granularity, one or more components of the system, for example the yield output engine 112, can utilize relationships between the parameters to establish a synthetic uniform granularity. For instance, a parameter at a higher level of granularity (e.g., physical attribute 201) might be extrapolated to supplement parameters at a lower level of granularity, or a parameter at a lower level of granularity (e.g., physical attribute 205) could be aggregated or averaged into a representative value at a higher level of granularity. In some embodiments, the formula that delineates a relationship between two observed parameters may be derived, at least in part, from the granularity levels of the involved physical attributes or a granularity level of an input for an aspect prediction model.

The normalization of data across various levels of granularity can be executed through several statistical techniques tailored to the specific characteristics of the data. For extrapolation, one common method is the nearest neighbor approach, which selects the closest data point at a finer granularity and uses its value to estimate missing data at a coarser granularity. Alternatively, averaging may be employed where values from multiple finer granularity data points are combined to produce an aggregate value representative of a higher granularity level. In some embodiments, regression techniques may be applied to establish a functional relationship between different granularity levels. For instance, a linear regression could be used to predict missing high granularity data based on available lower granularity data, fitting a model where the output at the higher granularity is a weighted sum of inputs from the lower granularity, adjusted by an intercept term derived from observed data patterns. These mathematical approaches can be designed to ensure consistency and accuracy in data used for modeling and analysis in semiconductor fabrication processes.

In addition to differing levels of granularity, comprehending the mathematical correlations between physical attributes of the semiconductor article-such as attributes 201, 203, and 205—and outcomes such as yield and tool maintenance presents complex challenges. The relationships between these attributes can be intricate and are not readily discernible, complicating the optimization of processes and prediction of outcomes.

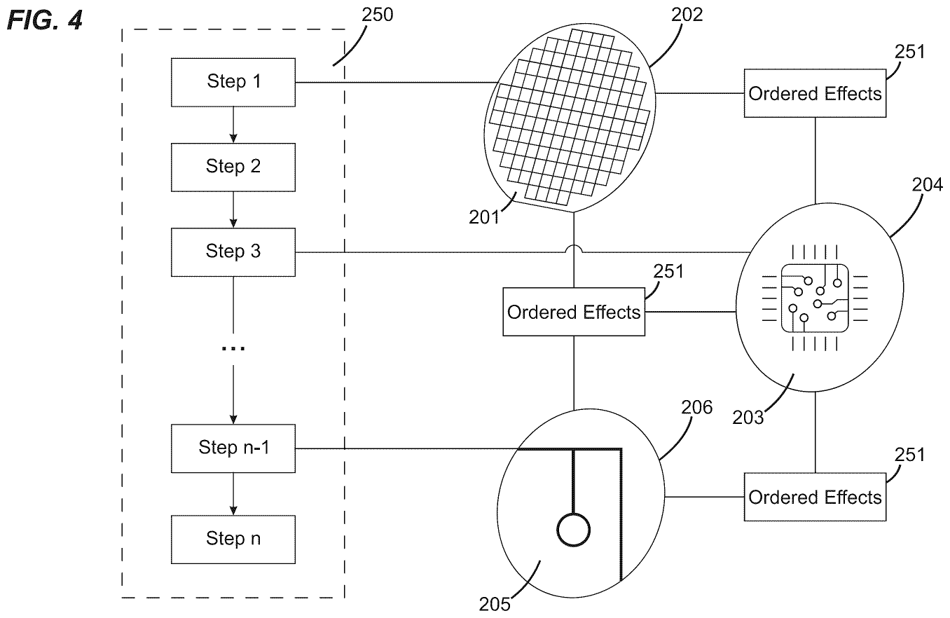

FIG. 4 illustrates a physical process 250 of semiconductor article fabrication, involving a series of steps during which physical attributes 201, 203, and 205 are observed. As shown, these physical attributes are measured at different stages of the semiconductor fabrication, and may influence different order effects. For instance, physical attribute 201 might be measured during the initial stages of fabrication, while physical attribute 205 is measured at later stages. Should there exist a correlation between these attributes, variations in physical attribute 201 could exert a more substantial impact on the final outcomes (e.g., the yield, Y) compared to variations in other physical attributes (e.g., physical attributes 203, 205), or conversely. This is attributable to the potential for changes in one attribute to either amplify or reduce the effects on another. Consequently, understanding the temporal relationship between physical attributes 201, 203, and 205 measured at different stages during fabrication can be important for further optimizing the process and achieving the desired outcomes.

The present disclosure proposes a methodology for predicting aspects of a semiconductor fabrication process by constructing a machine learning model. In some embodiments, this can involve supplying a computing device (e.g., yield output engine 112) with two or more parameters associated with different physical attributes of the manufactured semiconductor articles at various levels of granularity (e.g., physical attributes 201, 203, 205, etc.), and defining a mathematical relationship among them. By implementing this approach, the model can be capable of effectively analyzing and assimilating data collected at diverse levels of granularity, thus enabling prediction of the relationships between physical attributes and various outcomes such as yield, fabrication tool maintenance, metrology tool and/or inspection tool maintenance, or other optimization aspects of the semiconductor article.

Various mathematical methodologies can be employed to calculate relationships between multiple parameters observed during a semiconductor fabrication process. One effective approach involves observing variations among parameters X1, X2, and X3, which represent inputs in the fabrication process, across a range of samples to empirically determine their impact on the output, represented by Y, which can denote the yield or another outcome (e.g., f(X1, X2, X3)=Y). This method allows for the exploration of interactions between the input variables and their collective effect on the output, thereby facilitating the identification of optimal process settings that maximize yield.

Incorporating these findings, a mathematical model can be tuned to enhance its predictive accuracy. The mathematical model, designed to predict the outcome Y based on inputs X1, X2, and X3, can be augmented by integrating the relationship information derived from the systematic variation of inputs as additional inputs. This integration can involve modifying the model's architecture to include ordered effects 251 that specifically process the relationship data, effectively enabling the network to understand and incorporate complex interactions and dependencies among the input variables. For instance, the model might include additional neurons that are trained on interaction terms such as X1X2, X1X3, and X2X3, or even higher-order interactions if necessary. By training the model with these expanded inputs, it can learn to predict Y not only based on the individual effects of X1, X2, and X3 but also their combined effects as elucidated through the systematic input variation.

In some embodiments, the yield output engine 112 can be configured to execute the aforementioned processes, as well as various other processes generally directed towards predicting aspects of a semiconductor fabrication process. This configuration can enable the yield output engine 112 to utilize data from different levels of granularity, apply mathematical models for extrapolation and averaging, and integrate complex relationships among physical attributes into predictive algorithms. By systematically adjusting the input parameters and analyzing their impacts through refined computational models, the yield output engine 112 can further optimize the processing parameters to improve overall yield, enhance tool usage and maintenance efficiency, and ensure robust metrology practices.

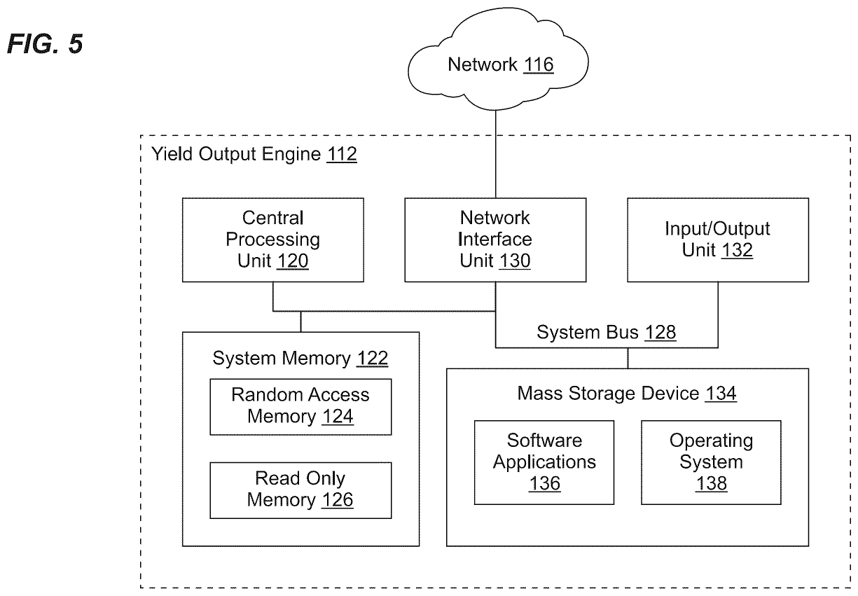

In the configuration depicted in FIG. 5, the yield output engine 112 can include at least one central processing unit (CPU)/graphics processing unit (GPU) 130, system memory 122, and a system bus 128 that connects the system memory 122 to the CPU/GPU 120. Both CPUs and GPUs may be employed to execute the machine learning models involved; CPUs handle general processing tasks, while GPUs provide specialized acceleration for data-intensive operations. As such, the terms CPU and GPU are used interchangeably here to indicate the processing units capable of facilitating machine learning computations. Within the system memory 122 are included a random access memory (RAM) 124 and a read-only memory (ROM) 126. The ROM 126 houses a basic input/output system which contains routines aiding in the transfer of information within computer system 100 during start-up and other operations. The computer system 100 also incorporates a mass storage device 134, designed to store software instructions and other data.

The mass storage device 134 can interface with the CPU/GPU 120 via a mass storage controller (not depicted) linked to the system bus 128. The mass storage device 134, along with its associated computer-readable data storage media, can provide durable and retrievable storage for the computer system 100. It is noted that the term “computer-readable data storage media” includes any physical media—volatile or non-volatile, removable or non-removable—that can store information accessible by the computer system, such as software, data structures, and program modules.

Types of computer-readable data storage media can include, but are not limited to, RAM, ROM, EPROM, EEPROM, flash memory, CD-ROMs, DVDs, and other optical media, magnetic cassettes, magnetic tape, magnetic disk storage, or any other medium which can store information and be accessed by the yield output engine 112.

In some embodiments, the computer system 100 operates within a networked environment using logical connections to connect to remote network devices via network 116. This network connection can be established over wired or wireless connections and can include local area networks or wide area networks like the Internet. The network 116 can utilize a multitude of communication protocols to facilitate network connectivity.

The network interface unit 130 connects the yield output engine 112 to the network 116 and may be utilized for connecting to other networks and remote computing systems. Additionally, an input/output controller 132 can be included within the yield output engine 112 to manage inputs from, and outputs to, various devices such as a touchscreen user interface or other peripheral devices.

As previously noted, the mass storage device 134 and RAM 124 of the yield output engine 112 can house software instructions and data. An operating system 138 stored on these devices manages the operations of the yield output engine 112. Software applications 136, when executed by the CPU/GPU 120, enable the yield output engine 112 to perform the functionalities as discussed herein.

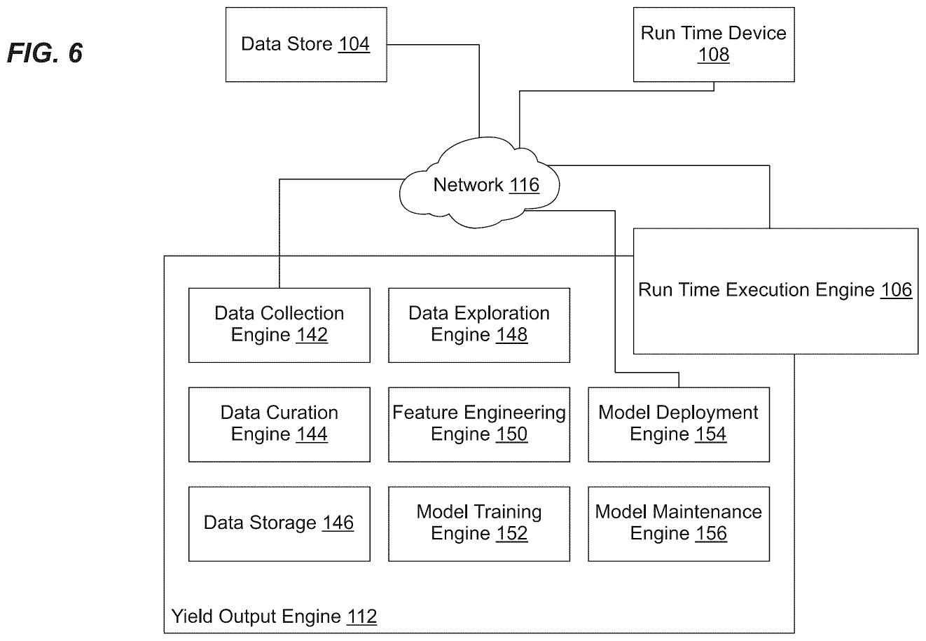

As shown in FIG. 6, the yield output engine 112 can include one or more engines, with each engine configured as a specialized component adapted to perform specific computational processing tasks within the computer system 100. In particular, the yield output engine 112 can comprise a machine learning model configured to generate a semiconductor fabrication process prediction. In some embodiments, the yield output engine 112 can include a data collection engine 142 configured to interface with fabrication data source 102 (e.g., tools 101A, 101B, 101C, etc.), a data curation engine 144, data storage 146, a data exploration engine 148, a feature engineering engine 150, a model training engine 152, a model deployment engine 154, and a model maintenance engine 156.

In embodiments, the yield output engine 112 can be configured to enable data to be collected, curated to minimize its under-inclusiveness and over-inclusiveness depending on the types of prediction(s) to be made by the model, and to provide the information to an artificial intelligence or machine learning algorithm model with curated data and providing the model with known relationships between parameters of the curated data, which can include, for example, relationships between parameters at different levels of granularity, and relationships between parameters at different order effects.

The tools 101A, 101B, 101C (depicted in FIG. 2) can include various types of metrology tools and/or inspection tools, as well as sensors, databases, or other sources. Examples of such tools that can serve as data sources include scanning electron microscopes, atomic force microscopes, profilometers, ellipsometers, spectrometers, optical imaging tools, and X-ray diffraction tools, among others. The data collected from these metrology tools 101A, 101B, 101C, which can be stored in the data store 104, can be structured or unstructured, and it can be collected in real-time or stored in batches for later analysis.

The data collection engine 142 can be responsible for gathering the data from these sources. The data collection engine 142 can be designed to gather information autonomously from the sources, using various methods such as APIs, data feeds, or data pipelines. The data collection engine 142 can be programmed to collect data at various granular levels, such as wafer level, die level, or site level, and at various times during the fabrication process, providing a comprehensive view of the process and enabling the establishment of relationships between parameters at different order effects. The data collected by the data collection engine 142 can be structured or unstructured, and it can be collected in real-time or stored in batches for later analysis. In some embodiments, the data can be preprocessed to remove noise or outliers, or it can be used as is, depending on the needs of the machine learning models that will be used to analyze it. Additionally, in some embodiments, data collection engine 142 can be configured to remove duplicates, fill in missing values, correct errors, and convert data to standardized formats.

The data curation engine 144 can serve to identify patterns and correlations between parameters that may not be immediately apparent. For instance, the data curation engine 144 can collect data on the thickness of a particular layer at various stages of the fabrication process, and correlate it with data on the duration of a specific etching step, to identify the optimal combination of these parameters that will result in the highest yield. As an additional example, the data curation engine 144 can collect data on various physical attributes of the semiconductor articles, such as transistor speed or via resistance, and analyze the relationships between these attributes and other parameters to optimize the fabrication process.

To achieve this, the data curation engine 144 can employ various techniques, such as statistical analysis, machine learning, and data mining. For example, it can use clustering algorithms to group similar data points together, or regression analysis to identify the relationship between two variables. It can also use anomaly detection techniques to identify data points that deviate significantly from the norm, which may indicate the presence of a defect or other issue in the fabrication process.

The data curation engine 144 can work in conjunction with the data collection engine 142 to autonomously gather information at various granular levels, as well as at different times during the fabrication process. This can be instrumental in establishing relationships between parameters at different order effects and identifying optimal values for these parameters. By leveraging the insights provided by the data curation engine 144, manufacturers can make data-driven decisions that lead to improved yield, performance, and efficiency in semiconductor fabrication.

Following the data curation process, the curated data can be stored in data storage 146 such as a database or data warehouse, which can be either cloud-based or on-premises. It Is essential that the data storage solution can be designed for scalability and reliability to accommodate the large volume of data collected during the semiconductor fabrication process, ensuring that the data is available for future analysis and can be easily accessed when needed.

In some embodiments, the data exploration engine 148 is configured to analyze the curated data to identify patterns, relationships, and trends, which can be an iterative process that involves querying the data, visualizing it, and refining the analysis. The purpose of the data exploration engine 148 is to gain insights into the fabrication process and identify areas where improvements can be made. By exploring the data, it is possible to identify correlations between different parameters, detect anomalies or outliers, and understand how different factors impact yield or performance. The results of the data exploration process can be used to refine the machine learning models and improve the accuracy of the predictions.

The feature engineering engine 150 is responsible for selecting and transforming the relevant features of the data to improve the resulting model's accuracy. In some embodiments, the feature engineering engine 150 is configured to select the most predictive variables from the curated data, normalize the data to ensure that all variables have equal influence on the model, and create new features based on domain knowledge. For example, in a semiconductor fabrication process, the feature engineering engine 150 may create new features that combine data from multiple sensors to provide a more comprehensive understanding of a particular aspect of the process. In embodiments, one goal of the feature engineering engine 150 is to ensure that the data used to train the model is relevant, representative, and informative, so that the model can accurately predict the outcome of the process.

The model training engine 152 is responsible for creating and training a machine learning model that can predict an outcome of a semiconductor fabrication process. This involves selecting appropriate algorithms, hyperparameters, and training data to create a model that accurately captures the relationships between the various parameters of the process. The model can be trained using both labeled and unlabeled data, and various techniques can be used to prevent overfitting or underfitting. In embodiments, the curated data and engineered features can be used to train the AI/ML model. The model can be a supervised or unsupervised learning model, and the training process can involve hyperparameter tuning, cross-validation, and ensembling. Once the model is trained, it can be tested and evaluated using a validation dataset to ensure that it generalizes well to new data.

In some embodiments, the machine learning model for predicting the outcome of a semiconductor fabrication process can employ a neural network, such as a deep convolutional neural network (DCNN), etc. Neural networks belong to a class of computing referred to as machine learning, a subfield of computer science that gives computers the ability to learn without being explicitly programmed. Machine learning is based on the development of computer programs that can teach themselves to grow and change when exposed to new data. The machine learning used in this model may also belong to a class of computing referred to as deep learning (DL), which is a branch of machine learning that attempts to model high-level abstractions in data.

The neural networks in this model can be comprised of multiple layers that perform algorithms or transformations, and the signal path traverses from front to back. The number of layers is not significant and is use case dependent, but for practical purposes, a suitable range of layers is from two layers to a few tens of layers. The neural networks may have any suitable architecture and/or configuration known in the art, and modern neural network projects typically work with a few thousand to a few million neural units and millions of connections.

Each neuron in a layer can be connected to each neuron in the subsequent layer via a connection, and collectively, the weights and biases of the neurons can be tuned as the neural network learns how to correctly classify the observed parameters. The neural network can be configured to use a mathematical function to compute an output value, which can be a numerical value, graphical output, or combination of alphanumeric text computed using various functions, such as a linear function, sigmoid function, tanh function, rectified linear unit, or another function configured to avoid extreme output values that can create instability in the neural network.

The neural network can be trained using a cost function, such as a quadratic cost function or cross entropy cost function, to establish how close the actual output data of the output layer corresponds to the known outputs of the training data. The backpropagation algorithm can be used to compute the gradient descent of the cost function to locate a global minimum in the cost function and compute the partial derivative of the cost function with respect to any weight or bias in the neural network. The changes to the weights and biases can be limited to a learning rate to prevent overfitting of the neural network, and various methods of regularization, such as L1 and L2 regularization, can be employed as an aid in minimizing the cost function.

The inputs to the neural network can be normalized data 252 (e.g., derived from the physical attributes 201, 203, 205) (as depicted in FIG. 3) and ordered effects 251 (as depicted in FIG. 4) representing identified mathematical relationships between the physical attributes 201, 203, 205. The output can be a semiconductor fabrication process prediction, such as yield, fabrication tool maintenance, metrology tool and/or inspection tool maintenance, or another optimization aspect.

The model deployment engine 154, which can communicate with the runtime execution engine 106 and runtime device 108, is responsible for deploying the trained model in a production environment, where it can make predictions on new data. This involves integrating the model with other systems, such as APIs or web applications, to enable real-time access to the model's predictions. The deployment process also includes monitoring the model's performance, ensuring that it is accurate and reliable in its predictions. Although the yield output engine 112 and runtime execution engine 106 are depicted as separate components, in some embodiments, these engines may be combined within a single device, such as a server or a bank of servers, to streamline operations and reduce system complexity.

In embodiments, the model maintenance engine 156 is responsible for monitoring and maintaining the deployed model over time to ensure its accuracy and effectiveness. In some embodiments, this can involve regularly retraining the model with new data and updating the feature engineering process to adapt to changing data patterns. The model maintenance engine 156 also monitors the data sources for changes or anomalies that may affect the model's performance, and takes appropriate action to ensure the model's accuracy and reliability.

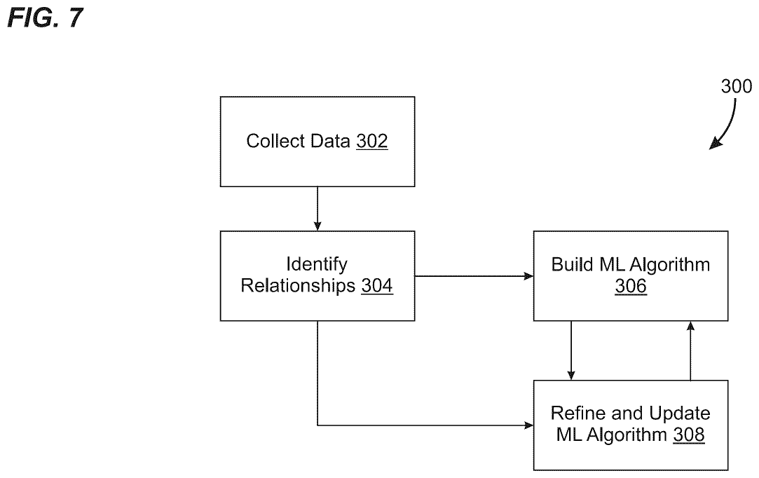

With additional reference to FIG. 7, a flowchart illustrating a method 300 of building a machine learning model for curated parameter data and known relationships between parameters, is depicted in accordance with an embodiment of the disclosure. In embodiments, the method 300 can involve a data collection step 302, a relationship identification step 304 in which relationships between the collected data are identified, an algorithm building step 306, and a step 308 in which the algorithm can be refined and updated.

The data collection step 302 involves the data collection engine 142, which is responsible for gathering data from the data store 104. The data collection engine 142 operates autonomously, utilizing various methods from different sources. The data collection step 302 is designed to collect data at various granular levels, such as wafer level, die level, or site level, and at various stages during the fabrication process to provide a comprehensive view of the process. The data collected during the data collection step 302 can be structured or unstructured and can be collected in real-time or batches. Additionally, the data can be preprocessed to remove noise or outliers, or it can be used as is, depending on the needs of the machine learning models that will be used to analyze it. In embodiments, the data collection step 302 can involve removing duplicates, filling in missing values, correcting errors, and converting data to standardized formats to ensure the data is ready for analysis.

In the relationship identification step 304, the data curation engine can analyze the data collected to identify relationships between parameters at different levels of granularity or order effects. By using techniques such as statistical analysis, machine learning, and data mining, the relationship identification step 304 can identify patterns and correlations that may not be immediately apparent, which can lead to improved yield, performance, and efficiency in semiconductor fabrication.

The algorithm building step 306 involves using the curated data and established parameter relationships to create and train a machine learning model that can predict the outcome of a semiconductor fabrication process. The model training engine 152 is responsible for selecting the appropriate algorithms, hyperparameters, and training data to build a model that accurately captures the relationships between the various parameters of the process. The model can be trained using both labeled and unlabeled data, and various techniques can be used to prevent overfitting or underfitting. In some embodiments, the machine learning model can be a neural network that includes an input layer, one or more hidden layers, and an output layer, with each layer comprising a corresponding number of neurons. The inputs to the model can be any number along a continuous range, such as values representing image pixels from a wafer inspection tool, and the output can be a semiconductor fabrication process prediction, such as yield, maintenance, or optimization. The model can be trained using a cost function and the backpropagation algorithm to compute the gradient descent of the cost function and adjust the weights and biases of the model to minimize the cost function. By using the insights gained from the data curation engine 144, the machine learning model can be trained to accurately predict the outcomes of semiconductor fabrication processes, leading to improved yield, performance, and efficiency.

At step 308, the model is optionally refined and updated based on new data and feedback, enabling performance of the model to be monitored to ensure that it remains accurate and efficient. This monitoring process can involve comparing the predicted outcomes to the actual outcomes of new fabrication runs and adjusting the model's parameters accordingly. If the model's performance is not up to the desired level, it can be retrained with new data or using different algorithms or hyperparameters until the desired accuracy is achieved. By continually, periodically or occasionally refining and updating the model based on new data and feedback, manufacturers can make more informed decisions and optimize the fabrication process for improved yield, performance, and efficiency.

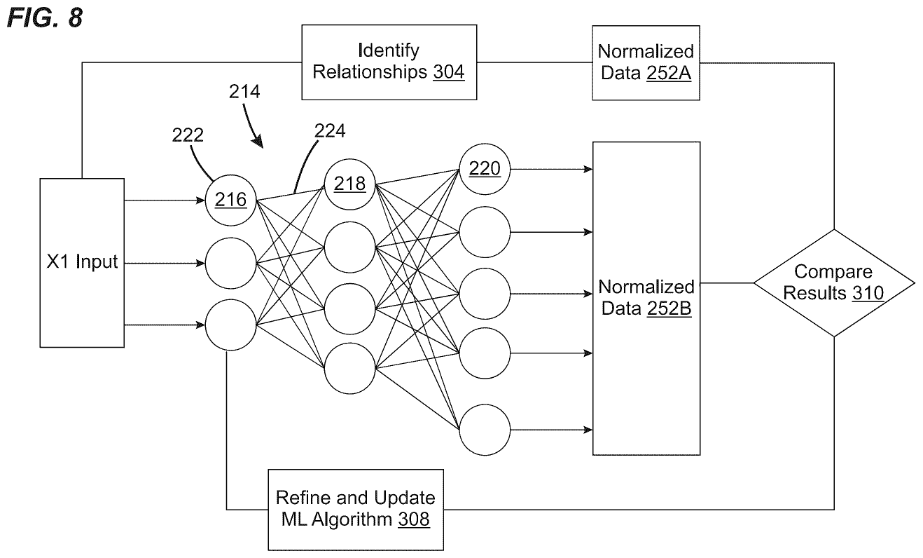

FIG. 8 depicts an example of a deep learning model in the form of a feedforward model (FFM) 214, in accordance with an embodiment of the disclosure. As depicted, the FFM 214 can include an input layer 216, one or more hidden layers 218, and an output layer 220. Each of these layers, 216, 218, and 220, contains a plurality of neurons 222. Although the illustration shows only a single hidden layer 218, it should be noted that multiple hidden layers 218 may be included in the FFM 214. The inputs for the input layer are typically numerical values, for example ranging between 0 and 1. For instance, the input layer 216 can incorporate one neuron for each input data point (e.g., X1, X2, X3, etc.) or causal factor under evaluation, with each neuron's value in the input layer 216 ranging between 0 and 1; however, configurations with varying numbers of neurons and input values are also considered.

As depicted, neurons 222 in one layer, such as the input layer 216, are connected to neurons 222 in a subsequent layer, like the hidden layer 218, through connections 224, establishing a fully connected network architecture. It is also conceivable that the FFM 214 can be structured as a convolutional network, where one or more groups of neurons 222 within a layer are linked to corresponding neurons in a subsequent layer, each group sharing a weighted value.

Each neuron 222 is configured to receive one or more input values (X1 Input) and compute an output value (e.g., normalized data 252B, etc.). In fully connected networks, each neuron 222 is assigned a bias value (b), and each connection 224 is assigned a weight value (w). These weights and biases are adjustable as the FFM 214 learns to identify patterns within the data. The function of each neuron 222 is defined mathematically, where the output y is a function of the weighted sum of inputs and the bias of the neuron.

The output (y) of each neuron 222 in some embodiments can range between 0 and 1. Moreover, the output of each neuron 222 may be determined by various activation functions, including linear, sigmoid, tanh, and rectified linear unit functions, configured to generally inhibit saturation and stabilize the FFM 214.

The output layer 220 may include neurons 222 corresponding to the required number of outputs for the FFM 214. For instance, the output layer 220 might feature an array of output neurons for use in additional computations. Alternate configurations with different numbers of output neurons are also envisaged.

The primary objective of the deep learning algorithm is to fine-tune the weights and biases of the FFM 214 until the inputs at the input layer 216 are accurately mapped to the desired outputs at the output layer 220, thereby enabling the FFM 214 to consistently generate outputs for previously unseen inputs. For example, with data from the physical attribute data inputted into the input layer 216, the FFM 214 aims to normalize the data to account for varying levels of granularity to produce normalized data 252B.

In optimizing the FFM 214, a cost function, such as a quadratic cost function or cross entropy, is utilized to measure how closely the actual outputs from the output layer 220 align with the known outputs from the training data. The FFM 214 can be trained through the step 304 of identifying relationships resulting in the production of normalized data 252A. Each complete cycle through the training dataset by the FFM 214 constitutes one epoch. Throughout multiple epochs, the weights and biases of the FFM 214 are adjusted iteratively to progressively minimize the cost function.

Effective optimization of the FFM 214 is pursued by implementing a gradient descent strategy on the cost function to seek a global minimum. Backpropagation is employed to calculate the gradient descent of the cost function, determining the partial derivatives of the cost function with respect to any weight (w) or bias (b) in the FFM 214. This process enables adjustments to weights and biases to be monitored as they propagate through the network, impacting the output and affecting the cost. An output of the FFM 214 (e.g., normalized data 252B) can be compared with the normalized data 252A at step 310. If it is determined that further optimization of the FFM 214 is desired, the respective weights and biases can be iteratively adjusted at step 308. To avoid overfitting, adjustments to weights and biases can be regulated by a learning rate. Additionally, regularization methods may be applied to further aid in minimizing the cost function.

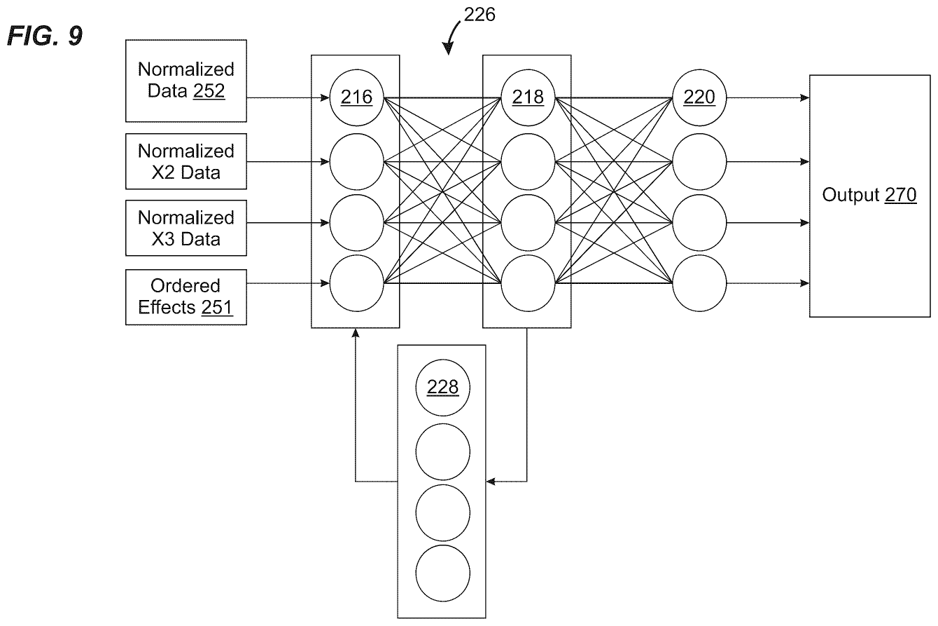

FIG. 9 illustrates an example deep learning model configured as a recurrent neural network (RNN) 226, in accordance with an embodiment of the disclosure. Unlike feedforward models where information flows unidirectionally from the input layer to the output layer without cycles or loops, the RNN 226 allows data from a prior hidden state to be reintroduced into the network's layers, endowing the network with a form of memory. This attribute enables the RNN to retain information across different points in a sequence, utilizing past insights to inform current data processing.

Distinct from feedforward neural networks that treat each input independently, the architecture of the RNN 226 with its hidden states facilitates the storage and utilization of information from previous steps or time points in the sequence. This capability provides the network with a memory that allows for an ordered effect to influence future outputs.

An important feature of the RNN 226 is its recurrent unit 228, which forms loops within the network structure, permitting information to persist from one time step to the next. These loops enable the network to comprehend the context and temporal dependencies within a sequence, with the hidden state serving as dynamic memory that retains vital information from earlier steps to influence subsequent data processing.

Within the RNN 226, each sequence step corresponds to a specific time point, and the input at each step is integrated with the hidden state from the prior step to generate an output while concurrently updating the hidden state. This integrative process often involves the sharing of the same set of weights across all time steps, enhancing the network's capability to identify and learn patterns and relationships that recur throughout the sequence.

To augment the neural network's capacity to capture long-term dependencies and maintain information over extended sequences, advanced variants such as Long Short-Term Memory (LSTM) units and Gated Recurrent Units (GRUs) can be employed. These models feature specialized gating mechanisms that manage the flow of information within the network, ensuring that pertinent data is sustained and irrelevant data is excluded, thus boosting the network's efficiency and efficacy in managing complex sequences.

Furthermore, inputs to the RNN 226 can include normalized data 252 (e.g., derived from physical attributes 201, 203, 205, etc.) as well as order defects 251, to produce output 270, which is predictive of an aspect of a semiconductor fabrication process. This inclusion allows the RNN to more accurately analyze and predict outcomes based on both the immediate and historical data context provided by the sequence of inputs.

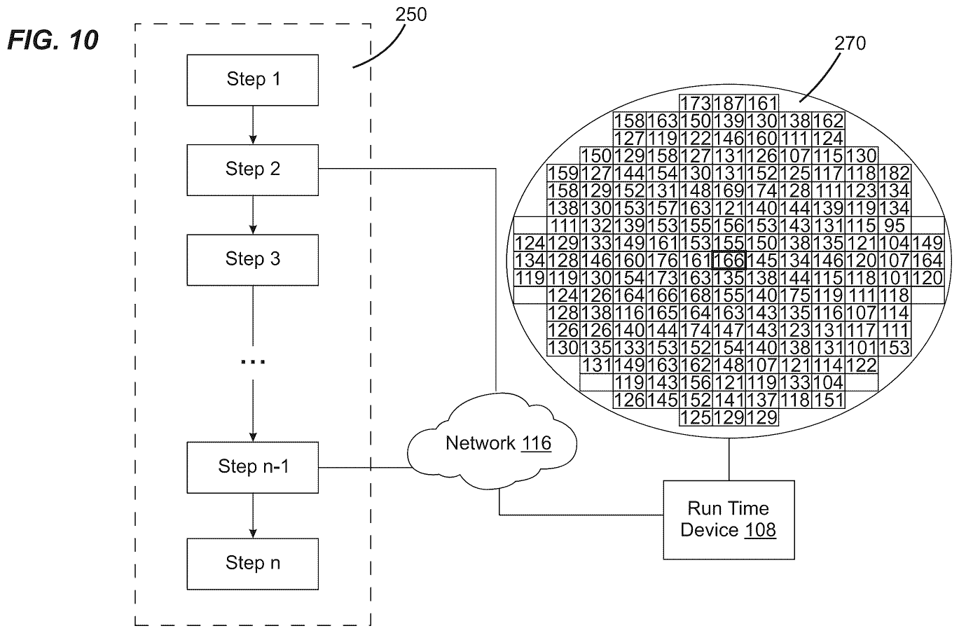

Referring to FIG. 10, in some embodiments, the machine learning model is designed to provide an output 270 representing predictions of semiconductor fabrication processes based on partially fabricated articles. The data used to generate these predictions can be manipulated and processed in various ways throughout the different steps of the method. In some cases, the data may be based on averages gathered from past fabrication processes, allowing the model to identify patterns and trends that can be applied to the current process. Additionally, the data can be based on observed trends, allowing the model to adjust its predictions in real-time as new data is collected.

Another approach involves extrapolating data from known models, allowing the model to predict outcomes based on historical data even when specific parameters are not available. These manipulations and processing of the data can be helpful in improving the accuracy and effectiveness of the model in predicting yield and other semiconductor fabrication process outcomes throughout the entire fabrication process.

In embodiments, the output of the machine learning algorithm can be represented in a diverse range of outputs that can be useful in understanding and optimizing semiconductor fabrication processes. One format is a graphical depiction that highlights the article yield, maintenance needs, or other predictions associated with different regions of the fabrication process. For example, the algorithm may produce a heat map that displays the yield associated with different process parameters, allowing manufacturers to quickly identify areas of the process that are producing lower yields and focus their efforts on improving those areas. In other embodiments, the output may be in a tabular or text format, which can be easily summarized and displayed by a user interface. This format can be useful for providing detailed information about the model's predictions, such as the specific parameters that are most strongly correlated with the predicted outcome, or the probability of a particular outcome occurring given a specific set of input parameters.

In certain embodiments, the machine learning algorithm can be used to simulate the effects of adjusting specific parameters during the fabrication process. This can be done either in actuality by physically adjusting the parameter, or virtually by making adjustments to the input data fed into the algorithm. For instance, the algorithm can simulate the effect of changing the temperature or duration of a particular step in the process, and predict the resulting article yield, maintenance needs, or other relevant factors. By allowing manufacturers to experiment with different parameter combinations in a virtual environment, the machine learning algorithm can help optimize the fabrication process before changes are made in the physical environment. This can lead to significant cost savings and improved efficiency, as manufacturers can identify optimal parameter combinations and avoid costly trial and error in the physical environment.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A method of predicting an aspect of a semiconductor fabrication process, comprising:
building a machine learning model, including:
providing, to a computing device, two parameters of one or more manufactured semiconductor articles, the two parameters being associated with different physical attributes of the one or more semiconductor articles that are at different levels of granularity; and
providing, to the computing device, a mathematical relationship between the two parameters based on the different levels of granularity; and
generating, by the machine learning model, a prediction of the semiconductor fabrication process.

2. The method of claim 1, wherein the different physical attributes have physical sizes that are different from each other by at least an order of magnitude.

3. The method of claim 1, wherein building the machine learning model includes:
providing, to the computing device, a third parameter of the one or more manufactured semiconductor articles, the third parameter being associated with a physical attribute of the one or more manufactured semiconductor articles that is larger than both the different levels of granularity; and
providing, to the computing device, a mathematical relationship between a first of the two parameters and the third parameter, and a mathematical relationship between a second of the two parameters and the third parameter.

4. The method of claim 1, wherein the mathematical relationship is based on an order in which steps of the semiconductor fabrication process that generate the different physical attributes are performed.

5. The method of claim 1, wherein the generating includes:
providing, to the machine learning model, data associated with a partially fabricated semiconductor article, the data missing a parameter value; and
assigning a value to a missing parameter value based on the mathematical relationship.

6. The method of claim 1, wherein the machine learning model is a recurrent neural network configured to process the two parameters over multiple sequence steps to capture temporal dependencies and patterns in the semiconductor fabrication process.

7. The method of claim 6, wherein inputs to the recurrent neural network further include order defects data associated with the semiconductor fabrication process.

8. The method of claim 6, wherein inputs to the recurrent neural network further include normalized data derived from the different physical attributes.

9. The method of claim 1, further comprising normalizing the two parameters into normalized data prior to providing the two parameters to the computing device to standardize data input into the machine learning model, the normalizing including aggregating data from a lower level of granularity to a higher level of granularity.

10. The method of claim 9, wherein the normalized data is compared to a set of pre-normalized data.

11. A computer system for predicting an aspect of a semiconductor fabrication process, comprising:
one or more processors; and
non-transitory computer-readable storage media encoding instructions which, when executed by the one or more processors, cause the computer system to:
build a machine learning model by:
providing, to a computing device, two parameters of one or more manufactured semiconductor articles, wherein the two parameters are associated with different physical attributes of the one or more semiconductor articles that are at different levels of granularity; and
providing, to the computing device, a mathematical relationship between the two parameters; and
generate, by the machine learning model, a prediction of the semiconductor fabrication process.

12. The computer system of claim 11, wherein the different physical attributes associated with the two parameters have physical sizes that are different from each other by at least an order of magnitude.

13. The computer system of claim 11, wherein to build the machine learning model further includes:
providing, to the computing device, a third parameter of the one or more manufactured semiconductor articles, the third parameter being associated with a physical attribute of the one or more manufactured semiconductor articles that is larger than both the different levels of granularity; and
providing, to the computing device, a mathematical relationship between a first of the two parameters and the third parameter, and a mathematical relationship between a second of the two parameters and the third parameter.

14. The computer system of claim 11, wherein the mathematical relationship is based on an order in which steps of the semiconductor fabrication process that generate the different physical attributes are performed.

15. The computer system of claim 11, wherein to generate includes to:
provide, to the machine learning model, data associated with a partially fabricated semiconductor article, the data missing a parameter value; and
assign a value to the missing parameter value based on the mathematical relationship.

16. The computer system of claim 11, wherein the machine learning model is a recurrent neural network configured to process the two parameters over multiple sequence steps to capture temporal dependencies and patterns in the semiconductor fabrication process.

17. The computer system of claim 16, wherein inputs to the recurrent neural network further include order defects data associated with the semiconductor fabrication process.

18. The computer system of claim 16, wherein inputs to the recurrent neural network further include normalized data derived from the different physical attributes.

19. The computer system of claim 11, wherein the instructions, when executed by the one or more processors, cause the computer system to:
normalize the two parameters into normalized data prior to providing the two parameters to the computing device to standardize data input into the machine learning model, including to aggregate data from a lower level of granularity to a higher level of granularity.

20. The computer system of claim 19, wherein the instructions, when executed by the one or more processors, cause the computer system to compare the normalized data to a set of pre-normalized data.

21. A method of predicting an outcome of a semiconductor fabrication process, comprising:
measuring a first physical attribute and a second physical attribute of one or more manufactured semiconductor articles, the first physical attribute being introduced to the one or more manufactured semiconductor articles before the second physical attribute and at a different fabrication step than the second physical attribute;
determining a first order effect on the outcome by the first physical attribute and a second order effect on the outcome by the second physical attribute, the second order effect being smaller than the first order effect; and
training a machine learning model to make predictions based on the first order effect and the second order effect.

22. The method of claim 21, further comprising:
providing a partially fabricated semiconductor article that does not include a physical attribute corresponding to the second physical attribute;
measuring a physical attribute of the partially fabricated semiconductor article corresponding to the first physical attribute; and
deploying the machine learning model to predict the outcome of the partially fabricated semiconductor article based on the physical attribute of the partially fabricated semiconductor article and based on relative magnitudes of the first order effect and the second order effect.

23. The method of claim 21, further comprising:
providing a partially fabricated semiconductor article that does not include a physical attribute corresponding to the second physical attribute;
measuring a physical attribute of the partially fabricated semiconductor article corresponding to the first physical attribute;
determining a mathematical relationship between the first physical attribute and the second physical attribute;
extrapolating the physical attribute of the partially fabricated semiconductor article corresponding to the second physical attribute based on the mathematical relationship to provide an extrapolated physical attribute; and
deploying the machine learning model to predict the outcome of the partially fabricated semiconductor article based on the physical attribute of the partially fabricated semiconductor article and based on the extrapolated physical attribute.

24. The method of claim 23, wherein the machine learning model predicts the outcome also based on relative magnitudes of the first order effect and the second order effect.

25. The method of claim 21, wherein the outcome includes a yield.
